(19) United States
(12) Patent Application Publication
(10) Pub. No.: US 2017/0188246 A1
(43) Pub. Date: Jun. 29, 2017

(54) WIRELESS APPARATUS AND FAILURE DECISION METHOD

(71) Applicant: FUJITSU LIMITED, Kawasaki-shi (JP)

(72) Inventors: Kunifumi TAMACHI, Kawasaki (JP); Akio SASAKI, Yokohama (JP); Shin WATANABE, Yokohama (JP)

(21) Appl. No.: 15/376,063

(22) Filed: Dec. 12, 2016

(30) Foreign Application Priority Data
Dec. 28, 2015 (JP) 2015-257015

(51) Int. Cl. H04W 24/06; H04L 5/14; H04J 3/14; H04L 12/26

(52) U.S. Cl. CPC H04W 24/06; H04L 43/0817; H04L 5/14; H04J 3/14

(57) ABSTRACT

A wireless apparatus includes a plurality of amplifiers coupled in series with each other and a processor coupled to the plurality of amplifiers and configured to: execute an outputting process to cause at least one of the plurality of amplifiers to operate in a way that length of duration in which the at least one of the plurality of amplifiers is set in on state or off state is different from at least one amplifier among rest of the plurality of amplifiers; execute a measurement process to measure power of a signal outputted from an amplifier at the last stage from among the plurality of amplifiers; and execute a decision process to decide a failure of each of the plurality of amplifiers based on a change amount of the power measured by the measurement process at each of the plurality of output timings.

### CROSS-REFERENCE TO RELATED APPLICATION

This application is based upon and claims the benefit of priority of the prior Japanese Patent Application No. 2015-257015, filed on Dec. 28, 2015, the entire contents of which are incorporated herein by reference.

### FIELD

The present embodiments relate to a wireless apparatus and a failure decision method.

### BACKGROUND

Heretofore, some wireless apparatus incorporated in a communication apparatus such as a base station includes a self-diagnosis function. For example, in a wireless apparatus that includes a plurality of amplifiers coupled in parallel, a technology is known that output power of each of the plurality of amplifiers is measured, and the measured output powers are compared with each other to decide a failure of each of the plurality of amplifiers.

As examples of the related art, Japanese Laid-open Patent Publication No. 3-198514 is known.

### SUMMARY

According to an aspect of the embodiments, a wireless apparatus includes a plurality of amplifiers coupled in series with each other and a processor coupled to the plurality of amplifiers and configured to: execute an outputting process to output a plurality of control signals for switching each of the plurality of amplifiers between on and off at a plurality of output timings, the outputting process causing at least one of the plurality of amplifiers to operate in a way that length of duration in which the at least one of the plurality of amplifiers is set in on state is different from at least one amplifier among rest of the plurality of amplifiers; execute a measurement process to measure power of a signal outputted from an amplifier at the last stage from among the plurality of amplifiers; and execute a decision process to decide a failure of each of the plurality of amplifiers based on a change amount of the power measured by the measurement process at each of the plurality of output timings.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram depicting an example of a wireless apparatus of an embodiment 1;

FIG. 2 is a view depicting an example of a “transient period” from a “transmission period” to a “reception period”;

FIG. 3 is a view illustrating processing operation of the wireless apparatus of the embodiment 1;

FIG. 4 is a view illustrating processing operation of the wireless apparatus of the embodiment 1;

FIG. 5 is a view illustrating processing operation of the wireless apparatus of the embodiment 1;

FIG. 6 is a view illustrating processing operation of the wireless apparatus of the embodiment 1;

FIG. 7 is a block diagram depicting an example of a wireless apparatus of an embodiment 2;

FIG. 8 is a view illustrating processing operation of the wireless apparatus of the embodiment 2;

FIG. 9 is a block diagram depicting an example of a wireless apparatus of an embodiment 3;

FIG. 10 is a view illustrating processing operation of the wireless apparatus of the embodiment 3;

FIG. 11 is a view illustrating processing operation of the wireless apparatus of the embodiment 3; and

FIG. 12 is a view depicting an example of a hardware configuration of a wireless apparatus.

### DESCRIPTION OF EMBODIMENTS

In related art, to appropriately decide a failure of each of a plurality of amplifiers coupled in series does not take into consideration.

As one aspect of the present embodiment, provided are solutions for being able to appropriately decide a failure of each of a plurality of amplifiers coupled in series.

In the following, embodiments of a wireless apparatus and a failure decision method disclosed in the present application are described in detail with reference to the drawings. It is to be noted that the disclosed technology are not limited by the embodiments. Further, elements having the same functions in the embodiments are denoted by the same reference symbols, and overlapping description of them is omitted herein.

### Embodiment 1

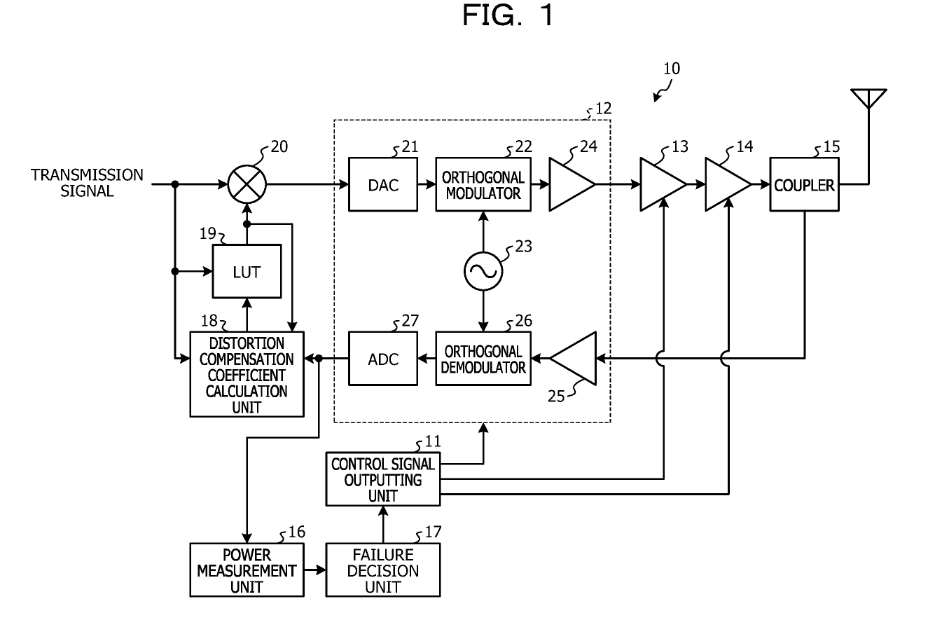

FIG. 1 is a block diagram depicting an example of a wireless apparatus of an embodiment 1. Referring to FIG. 1, a wireless apparatus 10 includes a control signal outputting unit 11, a transmission circuit 12, amplifiers 13 and 14, a coupler 15, a power measurement unit 16, a failure decision unit 17, a distortion compensation coefficient calculation unit 18, a lookup table (LUT) 19, and a multiplier 20. The transmission circuit 12 includes a digital to analog converter (DAC) 21, an orthogonal modulator 22, an oscillator 23, amplifiers 24 and 25, an orthogonal demodulator 26, and an analog to digital converter (ADC) 27. Further, to the wireless apparatus 10, a time division duplex (TDD) method that involves division in time into a “transmission period” and a “reception period” is applied.

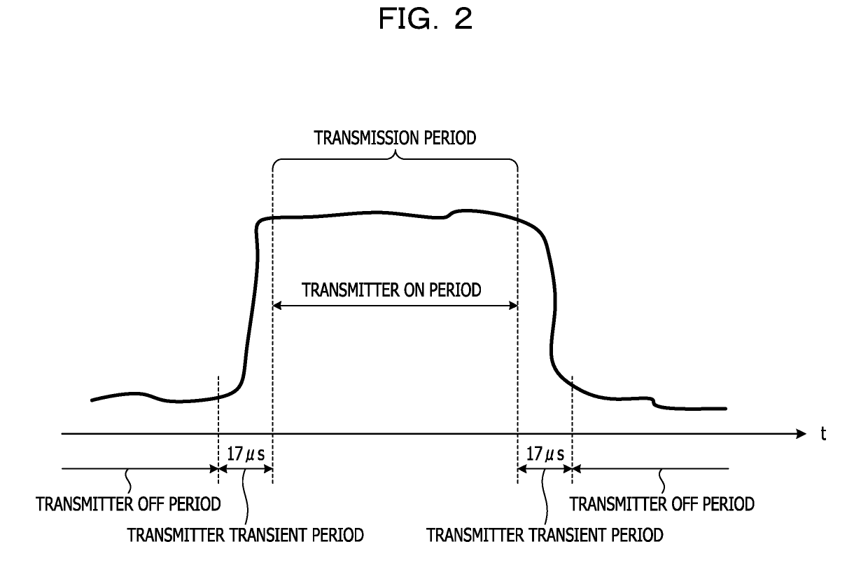

The control signal outputting unit 11 outputs a plurality of control signals for switching each of the amplifiers 13 and 14 between on and off at a “plurality of output timings” different from each other to the respective amplifiers 13 and 14 under the control of the failure decision unit 17. For example, the control signal outputting unit 11 outputs two control signals each for switching each of the amplifiers 13 and 14 from an on state to an off state at “a plurality of output timings” included in a “transient period” from a “transmission period” to a “reception period.” In the communication standards such as 3rd generation partnership project long term evolution (3GPP LTE), a “transient period” from a “transmission period” to a “reception period” is prescribed. For example, as depicted in FIG. 2, according to the communication standards of 3GPP LTE, it is prescribed that the time length of the Transmitter transient period that is a “transient period” from a “transmission period” to a “reception period” is a time length equal to or shorter than 17 microseconds. It is to be noted that FIG. 2 is a view illustrating an example of a “transient period” from a “transmission period” to a “reception period.”

Further, the control signal outputting unit 11 outputs a control signal for switching the transmission circuit 12 from an off state to an on state to the transmission circuit 12 at a start timing of a “transmission period.”

Further, the control signal outputting unit 11 outputs a control signal for switching the transmission circuit 12 from an on state to an off state to the transmission circuit 12 at an end timing of a “transmission period.”

The DAC 21 receives an input of a transmission signal outputted from the multiplier 20 and performs digital to analog conversion for the transmission signal, and outputs a resulting analog transmission signal to the orthogonal modulator 22. Further, the DAC 21 is placed from an on state into an off state in response to a control signal from the control signal outputting unit 11 at an end timing of a “transmission period.”

The orthogonal modulator 22 performs, within a “transmission period,” orthogonal modulation and up convert for an analog transmission signal received from the DAC 21 using a local signal outputted from the oscillator 23 and outputs a resulting wireless transmission signal to the amplifier 24. Further, the orthogonal modulator 22 is placed from an on state into an off state in response to a control signal from the control signal outputting unit 11 at an end timing of a “transmission period.”

The amplifier 24 amplifies, within a “transmission period,” a wireless transmission signal outputted from the orthogonal modulator 22 and outputs the amplified wireless transmission signal to the amplifier 13. Further, the amplifier 24 is placed from an on state into an off state in response to a control signal from the control signal outputting unit 11 at an end timing of a “transmission period.”

The amplifiers 13 and 14 are coupled in series. The amplifier 13 amplifies, within a “transmission period,” a wireless transmission signal outputted from the amplifier 24 and outputs the amplified wireless transmission signal to the amplifier 14. Further, when the transmission circuit 12 (for example, the amplifier 24 and so forth) is placed into an off state at an end timing of a “transmission period,” the amplifier 13 amplifies a noise signal generated in the amplifier 13 and outputs the amplified noise signal to the amplifier 14. Further, within a “transient period” from a “transmission period” to a “reception period,” the amplifier 13 is placed from an on state into an off state in response to a control signal from the control signal outputting unit 11.

The amplifier 14 amplifies, within a “transmission period,” a wireless transmission signal outputted from the amplifier 24 and outputs the amplified wireless transmission signal to the coupler 15. Further, when the transmission circuit 12 (for example, the amplifier 24 and so forth) is placed into an off state at an end timing of a “transmission period,” the amplifier 14 amplifies a noise signal outputted from the amplifier 13 and a noise signal generated from the amplifier 14 and outputs the resulting noise signal to the coupler 15. Further, within a “transient period” from a “transmission period” to a “reception period,” the amplifier 14 is placed from an on state into an off state in response to a control signal from the control signal outputting unit 11. The amplifier 14 corresponds to an example of an “amplifier at the last stage.”

The coupler 15 distributes a wireless transmission signal or a noise signal outputted from the amplifier 14 to an antenna and the amplifier 25. The antenna transmits the signal inputted from the coupler 15.

The amplifier 25 amplifies a signal received from the coupler 15 and outputs the amplified signal to the orthogonal demodulator 26. Here, to the amplifier 25, a wireless transmission signal is inputted within a “transmission period,” and a noise signal is inputted within a “transient period” from a “transmission period” to a “reception period.”

The orthogonal demodulator 26 performs down convert and orthogonal demodulation for a signal received from the amplifier 25 using a local signal outputted from the oscillator 23 and outputs a resulting signal to the ADC 27.

The ADC 27 performs analog to digital conversion for a signal outputted from the orthogonal demodulator 26 and outputs a resulting digital signal to the power measurement unit 16 and the distortion compensation coefficient calculation unit 18.

The power measurement unit 16 measures the power of a signal outputted from the amplifier 14 (for example, a wireless transmission signal or a noise signal). For example, the power measurement unit 16 receives a signal outputted from the amplifier 14 through a “feedback path” and measures the power of the received signal. Here, the “feedback path” is a path including the amplifier 25, the orthogonal demodulator 26, and the ADC 27.

The failure decision unit 17 decides a failure of each of the amplifiers 13 and 14 based on a “change amount” of the power measured by the power measurement unit 16 at each of a “plurality of output timings” included in a “transient period” from a “transmission period” to a “reception period.” For example, the failure decision unit 17 controls the control signal outputting unit 11 to individually outputs two control signals for switching each of the amplifiers 13 and 14 from an on state to an off state at the “plurality of output timings” described above. For example, the failure decision unit 17 controls the control signal outputting unit 11 to output a control signal corresponding to the amplifier 13 at a “first output timing” and output a control signal corresponding to the amplifier 14 at a “second output timing” later than the “first output timing.” Then, the failure decision unit 17 decides a failure indicating that each of the amplifiers 13 and 14 does not switch to an off state based on the “change amount” of the power measured by the power measurement unit 16 at each of the “plurality of output timings.”

Here, an example of failure decision based on the “change amount” of the power measured by the power measurement unit 16 is described. The failure decision unit 17 calculates a “difference” between a value of the power measured by the power measurement unit 16 within a given period before each of the “plurality of output timings” and a value of the power measured by the power measurement unit 16 in a given period after each of the “plurality of output timings” as the “change amount” described above. Then, when the calculated value of the “difference” is smaller than a given threshold value, the failure decision unit 17 decides that a failure occurs in each of the amplifiers 13 and 14. For example, when the difference between a value of the power measured within the given period before the “first output timing” described above and a value of the power measured within the given period after the “first output timing” is smaller than the given threshold value, the failure decision unit 17 decides that a failure occurs in the amplifier 13. Further, when the difference between a value of the power measured within the given period before the “second output timing” described above and a value of the power measured within the given period after the “second output timing” is smaller than the given threshold value, the failure decision unit 17 decides that a failure occurs in the amplifier 14.

Now, another example of failure decision based on the “change amount” of the power measured by the power measurement unit 16 is described. The failure decision unit 17 calculates a “difference” between a value of the power measured by the power measurement unit 16 within a given period after each of a “plurality of output timings” and a value of the power of a signal to be outputted from the amplifier 14 within the given period as the “change amount” described above. Then, when the calculated value of the “difference” is higher than a given threshold value, the failure decision unit 17 decides that a failure occurs in each of the amplifiers 13 and 14. For example, when the difference between a value of the power measured within a given period after the “first output timing” described above and a value of the power of a signal to be outputted from the amplifier 14 within the given period is greater than the given threshold value, the failure decision unit 17 decides that a failure occurs in the amplifier 13. It is to be noted that the value of the power of a signal to be outputted from the amplifier 14 may be a value measured in advance upon fabrication or the like of the wireless apparatus 10.

The distortion compensation coefficient calculation unit 18 calculates, within a “transmission period,” an update value for a distortion compensation coefficient on the basis of a transmission signal, a feedback signal from the “feedback path,” and a distortion compensation coefficient outputted from the LUT 19 to the multiplier 20. Then, the distortion compensation coefficient calculation unit 18 updates the LUT 19 with the calculated update value for a distortion compensation coefficient. Consequently, the distortion compensation coefficient is updated so as to reduce the difference between the transmission signal and the feedback signal.

The LUT 19 reads out a distortion compensation coefficient from the table using an amplitude value of a transmission signal as an address and outputs the read out distortion compensation coefficient to the multiplier 20 and the distortion compensation coefficient calculation unit 18.

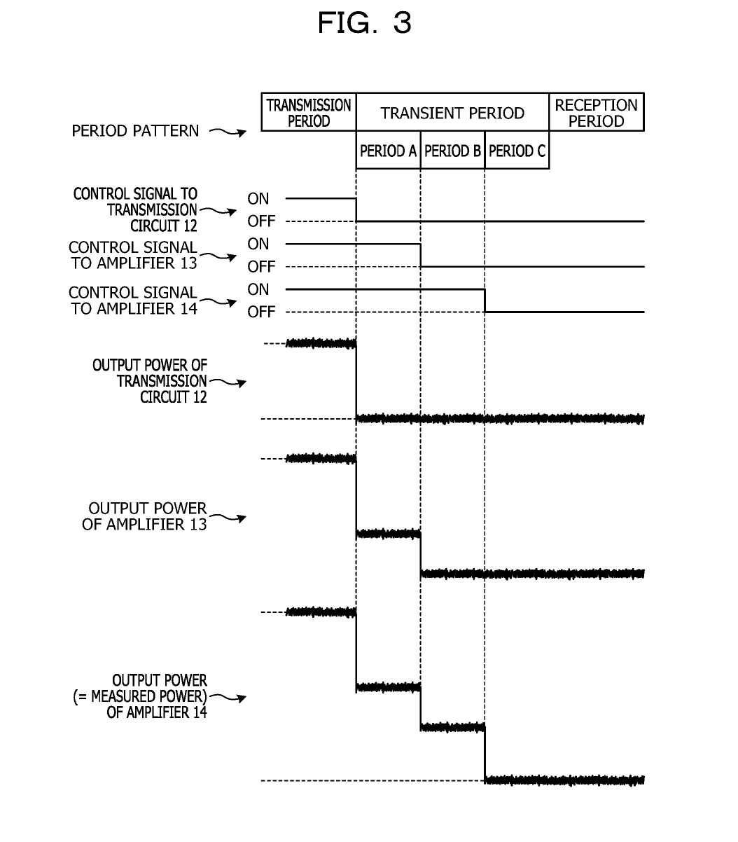

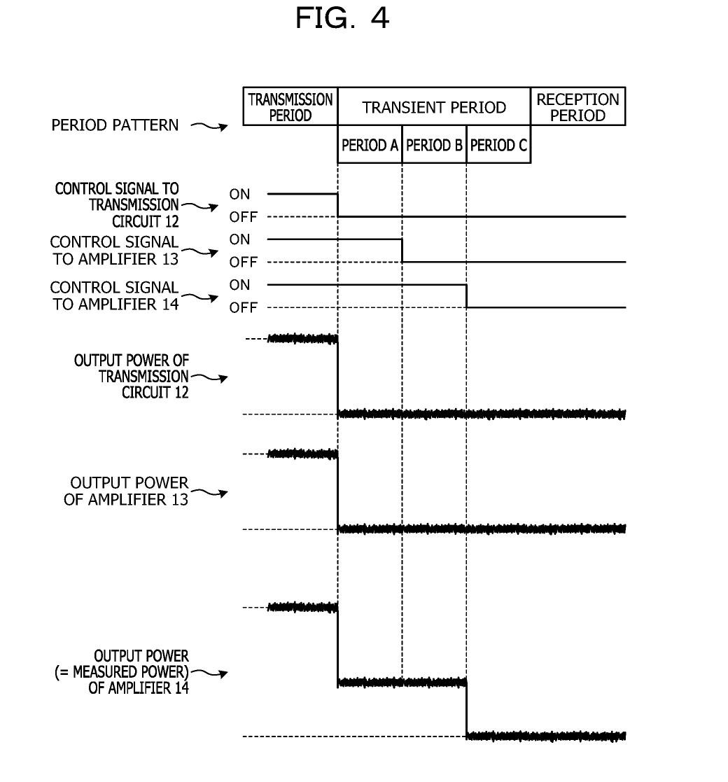

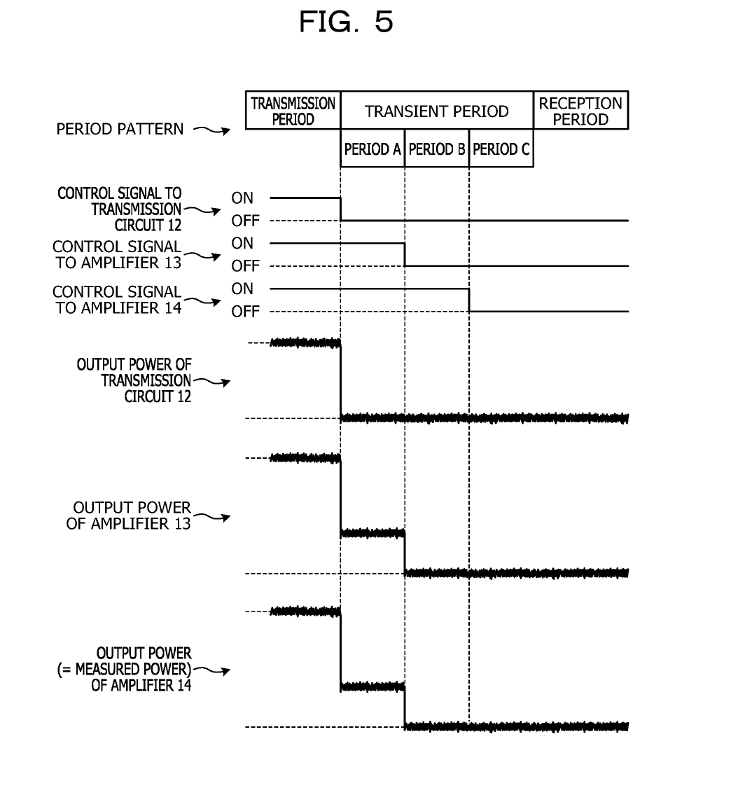

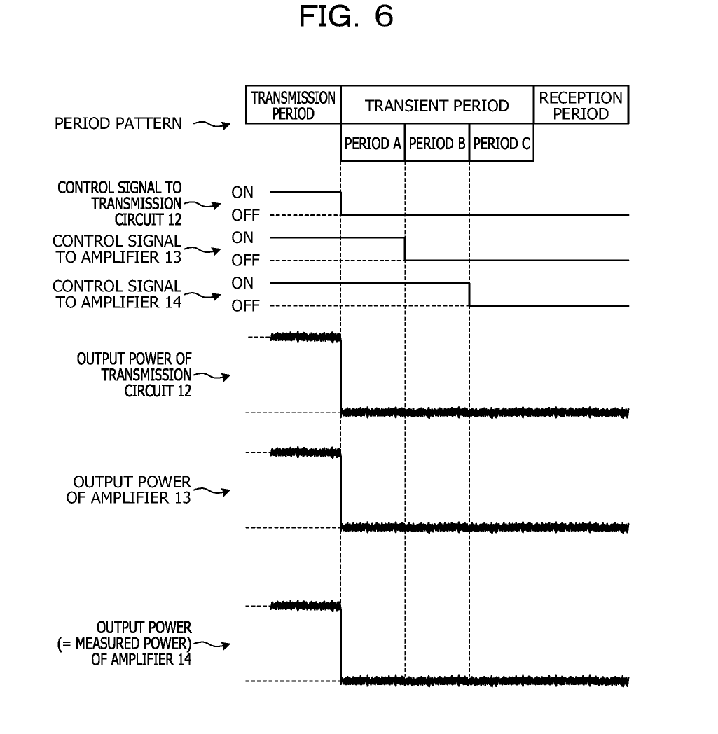

The multiplier 20 multiplies a transmission signal by a distortion compensation coefficient from the LUT 19 and outputs a transmission signal after the distortion compensation process to the DAC 21.

[Example of Operation of Wireless Apparatus] An example of processing operation of the wireless apparatus 10 having the configuration described above is described. FIGS. 3 to 6 are views illustrating processing operations of the wireless apparatus of the embodiment 1. FIG. 3 relates to processing operation of a failure decision method by the wireless apparatus 10 when neither of the amplifiers 13 and 14 fails. FIG. 4 relates to processing operation of a failure decision method by the wireless apparatus 10 when the amplifier 13 fails. FIG. 5 relates to processing operation of a failure decision method by the wireless apparatus 10 when the amplifier 14 fails. FIG. 6 relates to processing operation of a failure decision method by the wireless apparatus 10 when both of the amplifiers 13 and 14 fail.

First, processing operation when neither of the amplifiers 13 and 14 fails is described with reference to FIG. 3. It is assumed that, as depicted at the uppermost stage in FIG. 3, the period is switched in the order of a transmission period, a transient period, and a reception period.

As depicted at the second stage from above in FIG. 3, when the transmission period comes to an end, the control signal outputting unit 11 outputs a control signal for switching the transmission circuit 12 from an on state to an off state. Consequently, the transmission circuit 12 is placed into an off state, and outputting of a wireless transmission signal from the transmission circuit 12 (for example, the amplifier 24) is stopped.

Then, in response to the stopping of the outputting of a wireless transmission signal from the transmission circuit 12, the powers of signals outputted from the transmission circuit 12, the amplifier 13, and the amplifier 14 individually decrease as depicted at the fifth to seventh stages from above in FIG. 3.

Further, as depicted at the third stage from above in FIG. 3, the control signal outputting unit 11 outputs a control signal for switching the amplifier 13 from an on state to an off state under the control of the failure decision unit 17 at a “first output timing” later than the end timing of the transmission period. Since the amplifier 13 does not fail, the amplifier 13 is placed into an off state by the control signal, and outputting of a noise signal from the amplifier 13 is stopped.

Then, in response to the stopping of the outputting of a noise signal from the amplifier 13, the powers of signals outputted from the amplifier 13 and the amplifier 14 individually decrease as depicted at the sixth and seventh stages from above in FIG. 3. The power of a signal outputted from the amplifier 14 is measured by the power measurement unit 16. The failure decision unit 17 calculates the “difference” between a value of the power measured by the power measurement unit 16 within a period A before the “first output timing” described above and a value of the power measured by the power measurement unit 16 within a period B after the “first output timing.” The “difference” is greater than the given threshold value because the amplifier 13 is in an off state normally. Then, since the calculated value of the “difference” is higher than the given threshold value, the failure decision unit 17 decides that a failure does not occur in the amplifier 13.

Further, as depicted at the fourth stage from above in FIG. 3, the control signal outputting unit 11 outputs a control signal for switching the amplifier 14 from an on state to an off state under the control of the failure decision unit 17 at a “second output timing” later than the “first output timing.” Since the amplifier 14 does not fail, the amplifier 14 is switched to an off state by the control signal, and outputting of a noise signal from the amplifier 14 is stopped.

Then, in response to the stopping of the outputting of a noise signal from the amplifier 14, the power of a signal outputted from the amplifier 14 decreases as indicated at the seventh stage from above in FIG. 3. The power of a signal outputted from the amplifier 14 is measured by the power measurement unit 16. The failure decision unit 17 calculates the “difference” between a value of the power measured by the power measurement unit 16 within the period B before the “second output timing” described above and a value of the power measured by the power measurement unit 16 within a period C after the “second output timing.” The “difference” is greater than the given threshold value because the amplifier 14 is in an off state normally. Then, the failure decision unit 17 decides that a failure does not occur in the amplifier 14 because the calculated value of the “difference” is greater than the given threshold value.

Now, processing operation when the amplifier 13 fails is described with reference to FIG. 4. It is assumed that, as depicted at the uppermost stage in FIG. 4, the period is switched in the order of a transmission period, a transient period, and a reception period.

As depicted at the second stage from above in FIG. 4, when the transmission period comes to an end, the control signal outputting unit 11 outputs a control signal for switching the transmission circuit 12 from an on state to an off state. Consequently, the transmission circuit 12 is switched to an off state, and outputting of a wireless transmission signal from the transmission circuit 12 (for example, the amplifier 24) is stopped.

Then, in response to the stopping of the outputting of a wireless transmission signal from the transmission circuit 12, the powers of signals outputted from the transmission circuit 12, the amplifier 13, and the amplifier 14 individually decrease as depicted at the fifth to seventh stages from above in FIG. 4.

Further, as depicted at the third stage from above in FIG. 4, the control signal outputting unit 11 outputs a control signal for switching the amplifier 13 from an on state to an off state under the control of the failure decision unit 17 at a “first output timing” later than the end timing of the transmission period. Since the amplifier 13 fails, the amplifier 13 does not switch to an off state in response to the control signal, and outputting of a noise signal from the amplifier 13 is not stopped.

Consequently, the powers of signals outputted from the amplifier 13 and the amplifier 14 do not individually decrease as depicted at the sixth and seventh stages from above in FIG. 4. The power of a signal outputted from the amplifier 14 is measured by the power measurement unit 16. The failure decision unit 17 calculates the “difference” between a value of the power measured by the power measurement unit 16 within the period A before the “first output timing” described above and a value of the power measured by the power measurement unit 16 within the period B after the “first output timing.” The “difference” is smaller than the given threshold value because the amplifier 13 is in an on state. Then, the failure decision unit 17 decides that a failure occurs in the amplifier 13 because the calculated value of the “difference” is smaller than the given threshold value.

Further, as depicted at the fourth stage from above in FIG. 4, the control signal outputting unit 11 outputs a control signal for switching the amplifier 14 from an on state to an off state under the control of the failure decision unit 17 at a “second output timing” later than the “first output timing.” Since the amplifier 14 does not fail, the amplifier 14 is switched to an off state by the control signal, and outputting of a noise signal from the amplifier 14 is stopped.

Then, in response to the stopping of the outputting of a noise signal from the amplifier 14, the power of a signal outputted from the amplifier 14 decreases as indicated at the seventh stage from above in FIG. 4. The power of a signal outputted from the amplifier 14 is measured by the power measurement unit 16. The failure decision unit 17 calculates the “difference” between a value of the power measured by the power measurement unit 16 within the period B before the “second output timing” described above and a value of the power measured by the power measurement unit 16 within the period C after the “second output timing.” The “difference” is greater than the given threshold value because the amplifier 14 is in an off state normally. Then, the failure decision unit 17 decides that a failure does not occur in the amplifier 14 because the calculated value of the “difference” is greater than the given threshold value.

Now, processing operation when the amplifier 14 fails is described with reference to FIG. 5. It is assumed that, as depicted at the uppermost stage in FIG. 5, the period is switched in the order of a transmission period, a transient period, and a reception period.

As depicted at the second stage from above in FIG. 5, when the transmission period comes to an end, the control signal outputting unit 11 outputs a control signal for switching the transmission circuit 12 from an on state to an off state. Consequently, the transmission circuit 12 is switched to an off state, and outputting of a wireless transmission signal from the transmission circuit 12 (for example, the amplifier 24) is stopped.

Then, in response to the stopping of outputting of a wireless transmission signal from the transmission circuit 12, the powers of signals outputted from the transmission circuit 12, the amplifier 13, and the amplifier 14 individually decrease as depicted at the fifth to seventh stages from above in FIG. 5.

Further, as depicted at the third stage from above in FIG. 5, the control signal outputting unit 11 outputs a control signal for switching the amplifier 13 from an on state to an off state under the control of the failure decision unit 17 at a “first output timing” later than the end timing of the transmission period. Since the amplifier 13 does not fail, the amplifier 13 is switched to an off state by the control signal, and outputting of a noise signal from the amplifier 13 is stopped.

Then, in response to the stopping of the outputting of a noise signal from the amplifier 13, the powers of signals outputted from the amplifier 13 and the amplifier 14 individually decrease as indicated at the sixth and seventh stages from above in FIG. 5. The power of a signal outputted from the amplifier 14 is measured by the power measurement unit 16. The failure decision unit 17 calculates the “difference” between a value of the power measured by the power measurement unit 16 within the period A before the “first output timing” described above and a value of the power measured by the power measurement unit 16 within the period B after the “first output timing.” The “difference” is greater than the given threshold value because the amplifier 13 is in an off state normally. Then, the failure decision unit 17 decides that a failure does not occur in the amplifier 13 because the calculated value of the “difference” is higher than the given threshold value.

Further, as depicted at the fourth stage from above in FIG. 5, the control signal outputting unit 11 outputs a control signal for switching the amplifier 14 from an on state to an off state under the control of the failure decision unit 17 at the “second output timing” later than the “first output timing.” Since the amplifier 14 fails, the amplifier 14 is not switched to an off state by the control signal, and outputting of a noise signal from the amplifier 14 is not stopped.

Consequently, the power of a signal outputted from the amplifier 14 does not decrease as depicted at the seventh stage from above in FIG. 5. The power of a signal outputted from the amplifier 14 is measured by the power measurement unit 16. The failure decision unit 17 calculates the “difference” between a value of the power measured by the power measurement unit 16 within the period B before the “second output timing” described above and a value of the power measured by the power measurement unit 16 within the period C after the “second output timing.” The “difference” is smaller than the given threshold value because the amplifier 14 is in an on state. Then, the failure decision unit 17 decides that a failure occurs in the amplifier 14 because the calculated value of the “difference” is smaller than the given threshold value.

Now, processing operation when both of the amplifiers 13 and 14 fail is described with reference to FIG. 6. It is assumed that, as depicted at the uppermost stage in FIG. 6, the period is switched in the order of a transmission period, a transient period, and a reception period.

As depicted at the second stage from above in FIG. 6, when the transmission period comes to an end, the control signal outputting unit 11 outputs a control signal for switching the transmission circuit 12 from an on state to an off state under the control of the failure decision unit 17. Consequently, the transmission circuit 12 is switched into an off state, and outputting of a wireless transmission signal from the transmission circuit 12 (for example, the amplifier 24) is stopped.

Then, in response to the stopping of the outputting of a wireless transmission signal from the transmission circuit 12, the powers of signals outputted from the transmission circuit 12, the amplifier 13, and the amplifier 14 individually decrease as depicted at the fifth to seventh stages from above in FIG. 6.

Further, as depicted at the third stage from above in FIG. 6, the control signal outputting unit 11 outputs a control signal for switching the amplifier 13 from an on state to an off state under the control of the failure decision unit 17 at the “first output timing” later than the end timing of the transmission period. Since the amplifier 13 fails, the amplifier 13 is not switched to an off state by the control signal, and outputting of a noise signal from the amplifier 13 is not stopped.

Consequently, the powers of signals outputted from the amplifier 13 and the amplifier 14 do not individually decrease as depicted at the sixth and seventh stages from above in FIG. 6. The power of a signal outputted from the amplifier 14 is measured by the power measurement unit 16. The failure decision unit 17 calculates the “difference” between a value of the power measured by the power measurement unit 16 within the period A before the “first output timing” described above and a value of the power measured by the power measurement unit 16 within the period B after the “first output timing.” The “difference” is smaller than the given threshold value because the amplifier 13 is in an on state. Then, the failure decision unit 17 decides that a failure occurs in the amplifier 13 because the calculated value of the “difference” is lower than the given threshold value.

Further, as depicted at the fourth stage from above in FIG. 6, the control signal outputting unit 11 outputs a control signal for switching the amplifier 14 from an on state to an off state under the control of the failure decision unit 17 at the “second output timing” later than the “first output timing.” Since the amplifier 14 fails, the amplifier 14 is not switched to an off state by the control signal, and outputting of a noise signal from the amplifier 14 is not stopped.

Consequently, the power of a signal outputted from the amplifier 14 does not decrease as depicted at the seventh stage from above in FIG. 6. The power of a signal outputted from the amplifier 14 is measured by the power measurement unit 16. The failure decision unit 17 calculates the “difference” between a value of the power measured by the power measurement unit 16 within the period B before the “second output timing” described above and a value of the power measured by the power measurement unit 16 within the period C after the “second output timing.” The “difference” is smaller than the given threshold value because the amplifier 14 is in an on state. Then, the failure decision unit 17 decides that a failure occurs in the amplifier 14 because the calculated value of the “difference” is lower than the given threshold value.

As described above, according to the present embodiment, in the wireless apparatus 10, the control signal outputting unit 11 individually outputs a plurality of control signals for switching each of the amplifiers 13 and 14 coupled in series and at multiple stages between on and off at a plurality of output timings different from each other. The power measurement unit 16 measures the power of a signal outputted from the amplifier 14 that is an amplifier at the last stage from between the amplifiers 13 and 14. Then, the failure decision unit 17 decides a failure of each of the amplifiers 13 and 14 based on a change amount of the power measured by the power measurement unit 16 at each of the plurality of output timings.

By this configuration of the wireless apparatus 10, a failure of each of the amplifiers 13 and 14 coupled in series and at multiple stages can be decided appropriately.

Further, the TDD method that involves temporal division of a transmission period and a reception period is applied to the wireless apparatus 10. Thus, in the wireless apparatus 10, the control signal outputting unit 11 individually outputs a plurality of control signals for switching each of the amplifiers 13 and 14 from an on state to an off state at a plurality of output timings included in a transient period from a transmission period to a reception period. Then, the failure decision unit 17 decides a failure indicating that each of the amplifiers 13 and 14 does not switch to an off state based on a change amount of the power measured by the power measurement unit 16 at each of the plurality of output timings.

By this configuration of the wireless apparatus 10, a failure indicating that each of the amplifiers 13 and 14 coupled in series and at multiple stages does not switch to an off state can be decided appropriately.

### Embodiment 2

In an embodiment 2, a failure indicating that each of the amplifiers 13 and 14 does not switch to an on state within a transient period from a reception period to a transmission period is decided.

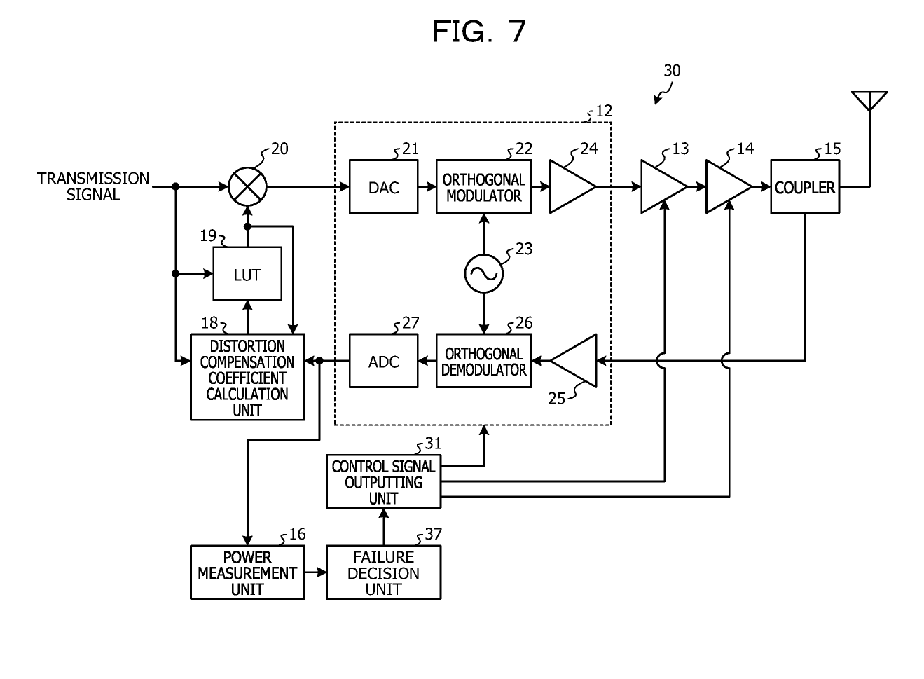

FIG. 7 is a block diagram depicting an example of a wireless apparatus of the embodiment 2. Referring to FIG. 7, a wireless apparatus 30 includes a control signal outputting unit 31 and a failure decision unit 37.

The control signal outputting unit 31 individually outputs two control signals for switching each of the amplifiers 13 and 14 from an on state to an off state at a “plurality of output timings” included in a “transient period” from a “transmission period” to a “reception period” similarly as in the embodiment 1. Further, the control signal outputting unit 31 outputs a control signal for switching the transmission circuit 12 from an off state to an on state at a start timing of a “transmission period” to the transmission circuit 12 similarly as in the embodiment 1. Further, the control signal outputting unit 31 outputs a control signal for switching the transmission circuit 12 from an on state to an off state to the transmission circuit 12 at an end timing of a “transmission period” similarly as in the embodiment 1.

Further, the control signal outputting unit 31 individually outputs two control signals for switching each of the amplifiers 13 and 14 from an off state to an on state at a “plurality of output timings” included in a “transient period” from a “reception period” to a “transmission period.”

The failure decision unit 37 decides a failure indicating that each of the amplifiers 13 and 14 does not switch to an off state based on a “change amount” of the power measured by the power measurement unit 16 at each of a “plurality of output timings” included in a “transient period” form a “transmission period” to a “reception period” similarly as in the embodiment 1.

Further, the failure decision unit 37 decides a failure of each of the amplifiers 13 and 14 based on the “change amount” of the power measured by the power measurement unit 16 at each of a “plurality of output timings” included in a “transient period” from a “reception period” to a “transmission period.” In the following description, a “plurality of output timings” included in a “transient period” from a “reception period” to a “transmission period” is referred to as a “plurality of output timings.” For example, the failure decision unit 37 controls the control signal outputting unit 31 to individually output two control signals for switching each of the amplifiers 13 and 14 from an off state to an on state at the “plurality of output timings” described above. For example, the failure decision unit 37 controls the control signal outputting unit 11 to output a control signal corresponding to the amplifier 14 at a “first output timing” and output a control signal corresponding to the amplifier 13 at a “second output timing” later than the “first output timing.” Then, the failure decision unit 37 decides a failure indicating that each of the amplifiers 13 and 14 does not switch to an on state based on the “change amount” of the power measured by the power measurement unit 16 at each of the “plurality of output timings.”

Here, an example of failure decision based on the “change amount” of the power measured by the power measurement unit 16 is described. The failure decision unit 37 calculates the “difference” between a value of the power measured by the power measurement unit 16 within a given period before each of a “plurality of output timings” and a value of the power measured by the power measurement unit 16 within a given period after each of the “plurality of output timings” as the “change amount” described above. Then, the failure decision unit 37 decides that a failure occurs in each of the amplifiers 13 and 14 when the calculated value of the “difference” is lower than a given threshold value. For example, when the difference between a value of the power measured within a given period before the “first output timing” described above and a value of the power measured within a given period after the “first output timing” is smaller than the given threshold value, the failure decision unit 37 decides that a failure occurs in the amplifier 14. Further, when the difference between a value of the power measured within a given period before the “second output timing” described above and a value of the power measured within a given period after the “second output timing” is smaller than the given threshold value, the failure decision unit 37 decides that a failure occurs in the amplifier 13.

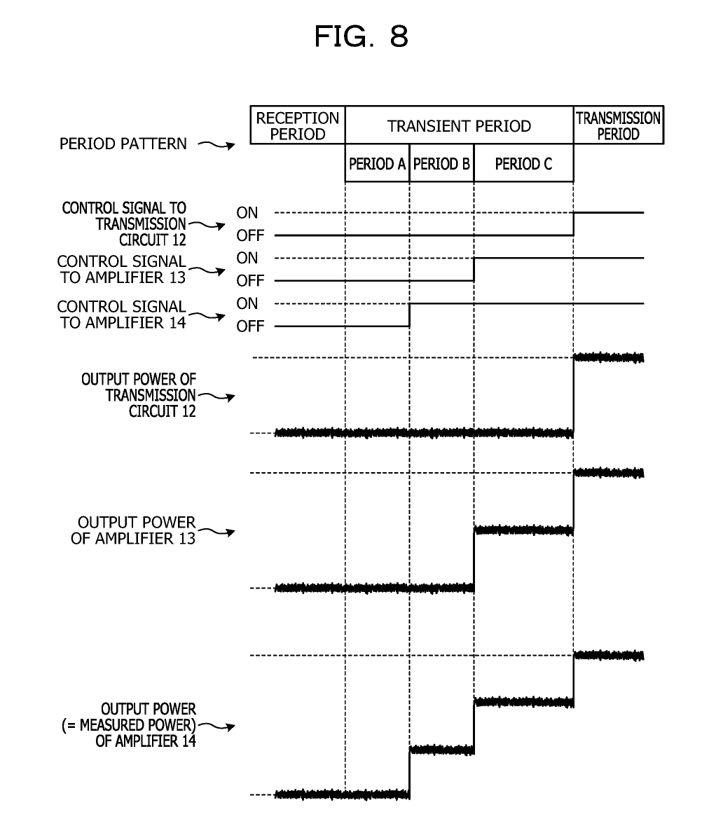

Now, another example of failure decision based on a “change amount” of the power measured by the power measurement unit 16 is described. The failure decision unit 37 calculates the “difference” between a value of the power measured by the power measurement unit 16 within a given period after each of a “plurality of output timings” and a value of the power of a signal to be outputted from the amplifier 14 within the given period as the “change amount” described above. Then, when the calculated value of the “difference” is higher than a given threshold value, the failure decision unit 37 decides that a failure occurs in each of the amplifiers 13 and 14. For example, when the difference between a value of the power measured within a given period after the “first output timing” described above and a value of the power of a signal to be outputted from the amplifier 14 within the given period is greater than the given threshold value, the failure decision unit 37 decides that a failure occurs in the amplifier 14. It is to be noted that the value of the power of a signal to be outputted from the amplifier 14 may be a value measured in advance upon fabrication or the like of the wireless apparatus 30.

<Example of Operation of Wireless Apparatus> An example of processing operation of the wireless apparatus 30 having the configuration described above is described. FIG. 8 is a view illustrating processing operation of the wireless apparatus of the embodiment 2. FIG. 8 relates to processing operation of a failure decision method by the wireless apparatus 30 when neither of the amplifiers 13 and 14 fails.

It is assumed that, as depicted at the uppermost stage in FIG. 8, the period is switched in the order of a reception period, a transient period, and a transmission period.

As depicted at the fourth stage from above in FIG. 8, the control signal outputting unit 31 outputs a control signal for switching the amplifier 14 from an off state to an on state under the control of the failure decision unit 37 at a “first output timing” later than an end timing of the reception period. Since the amplifier 14 does not fail, the amplifier 14 is placed into an on state by the control signal, and outputting of a noise signal from the amplifier 14 is started.

Then, in response to the starting of the outputting of a noise signal from the amplifier 14, the power of a signal outputted from the amplifier 14 increases as depicted at the seventh stage from above in FIG. 8. The power of a signal outputted from the amplifier 14 is measured by the power measurement unit 16. The failure decision unit 37 calculates the “difference” between a value of the power measured by the power measurement unit 16 within a period A before the “first output timing” described above and a value of the power measured by the power measurement unit 16 within a period B after the “first output timing.” Since the amplifier 14 is in a normal on state, the “difference” is greater than the given threshold value. Then, since the calculated value of the “difference” is higher than the given threshold value, the failure decision unit 37 decides that a failure does not occur in the amplifier 14.

Further, as depicted at the third stage from above in FIG. 8, the control signal outputting unit 31 outputs a control signal for switching the amplifier 13 from an off state to an on state under the control of the failure decision unit 37 at a “second output timing” later than the “first output timing.” Since the amplifier 13 does not fail, the amplifier 13 is placed into an on state by the control signal, and outputting of a noise signal from the amplifier 13 is started.

Then, in response to the starting of the outputting of a noise signal from the amplifier 13, the powers of signals outputted from the amplifier 13 and the amplifier 14 increase as depicted at the sixth and seventh stages from above in FIG. 8. The power of a signal outputted from the amplifier 14 is measured by the power measurement unit 16. The failure decision unit 37 calculates the “difference” between a value of the power measured by the power measurement unit 16 within a period B before the “second output timing” described above and a value of the power measured by the power measurement unit 16 within a period C after the “second output timing.” Since the amplifier 13 is in a normal on state, the “difference” is greater than the given threshold value. Then, since the calculated value of the “difference” is greater than the given threshold value, the failure decision unit 37 decides that a failure does not occur in the amplifier 13.

As described above, according to the present embodiment, in the wireless apparatus 30, the control signal outputting unit 31 individually outputs a plurality of control signals for switching each of the amplifiers 13 and 14 from an off state to an on state at a plurality of output timings included in a transient period from a reception period to a transmission period. Then, the failure decision unit 37 decides a failure indicating that each of the amplifiers 13 and 14 does not switch to an on state based on a change amount of the power measured by the power measurement unit 16 at each of the plurality of output timings.

By this configuration of the wireless apparatus 30, a failure indicating that each of the amplifiers 13 and 14 coupled in series does not switch to an on state can be decided appropriately.

### Embodiment 3

In an embodiment 3, every time a transient period comes, an amplifier of a decision target is changed and a control signal for switching the amplifier of the decision target after the change between on and off at a unique output timing is outputted to decide a failure of the amplifier of the decision target.

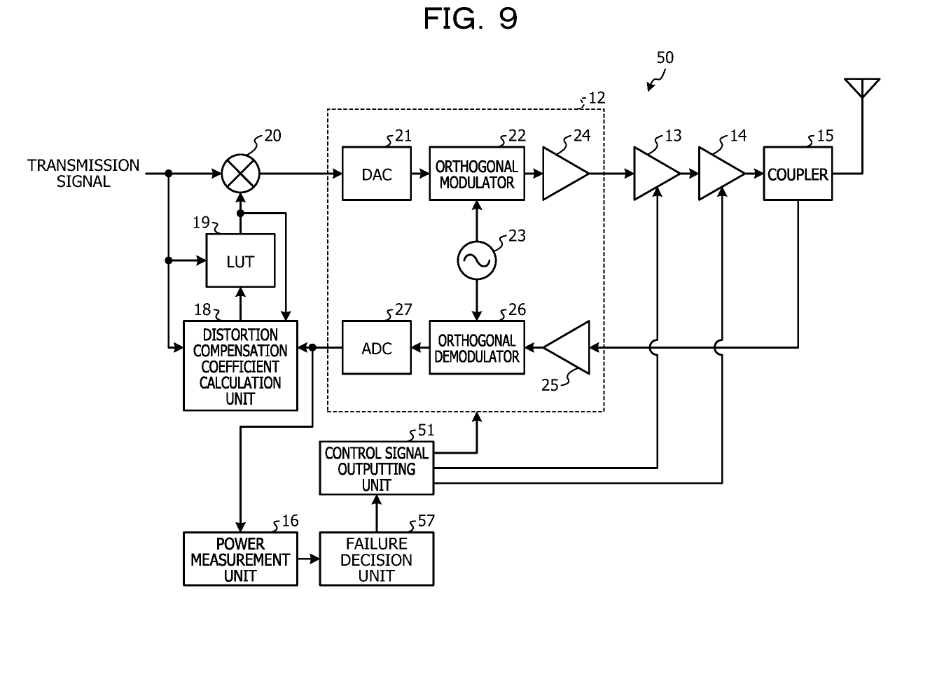

FIG. 9 is a block diagram depicting an example of a wireless apparatus of the embodiment 3. Referring to FIG. 9, a wireless apparatus 50 includes a control signal outputting unit 51 and a failure decision unit 57.

Every time a “transient period” comes, the control signal outputting unit 51 outputs a control signal for switching an “amplifier of the decision target” from between the amplifiers 13 and 14 between on and off at a timing later than an output timing of a control signal for switching an amplifier other than the “amplifier of the decision target” between on and off. In the present embodiment, it is assumed that the “transient period” is a “transient period” from a “transmission period” to a “reception period.” The “transient period” may otherwise be a “transient period” from a “reception period” to a “transmission period.”

Every time a “transient period” comes, the failure decision unit 57 changes the “amplifier of the decision target” and decides a failure of the “amplifier of the decision target” based on a “change amount” of the power measured by the power measurement unit 16 at an output timing corresponding to the “amplifier of the decision target” after the change. For example, when a “transient period” of the first time comes, the failure decision unit 57 sets the amplifier 13 as the “amplifier of the decision target.” Then, the failure decision unit 57 controls the control signal outputting unit 51 to output a control signal for switching the amplifier 13 from an on state to an off state at an output timing later than an output timing of a control signal corresponding to the amplifier 14. Then, the failure decision unit 57 decides a failure indicating that the amplifier 13 does not switch to an off state based on a “change amount” of the power measured by the power measurement unit 16 at the output timing corresponding to the amplifier 13. When a “transient period” of the second time comes, the failure decision unit 57 changes the “amplifier of the decision target” to the amplifier 14. Then, the failure decision unit 57 controls the control signal outputting unit 51 to output a control signal for switching the amplifier 14 from an on state to an off state at an output timing later than the output timing of the control signal corresponding to the amplifier 13. Then, the failure decision unit 57 decides a failure indicating that the amplifier 14 does not switch to an off state based on a “change amount” of the power measured by the power measurement unit 16 at the output timing corresponding to the amplifier 14.

Here, an example of failure decision based on a “change amount” of the power measured by the power measurement unit 16 is described. It is assumed that, in the following description, the amplifier 13 is the “amplifier of the decision target.” Further, in the following description, an output timing corresponding to the amplifier 13 is referred to as “decision target timing.” The failure decision unit 57 calculates the “difference” between a value of the power measured by the power measurement unit 16 within a given period before a “decision target timing” and a value of the power measured by the power measurement unit 16 within a given period after the “decision target timing” as the “change amount” described above. Then, when the calculated value of the “difference” is lower than a given threshold value, the failure decision unit 57 decides that a failure occurs in the amplifier.

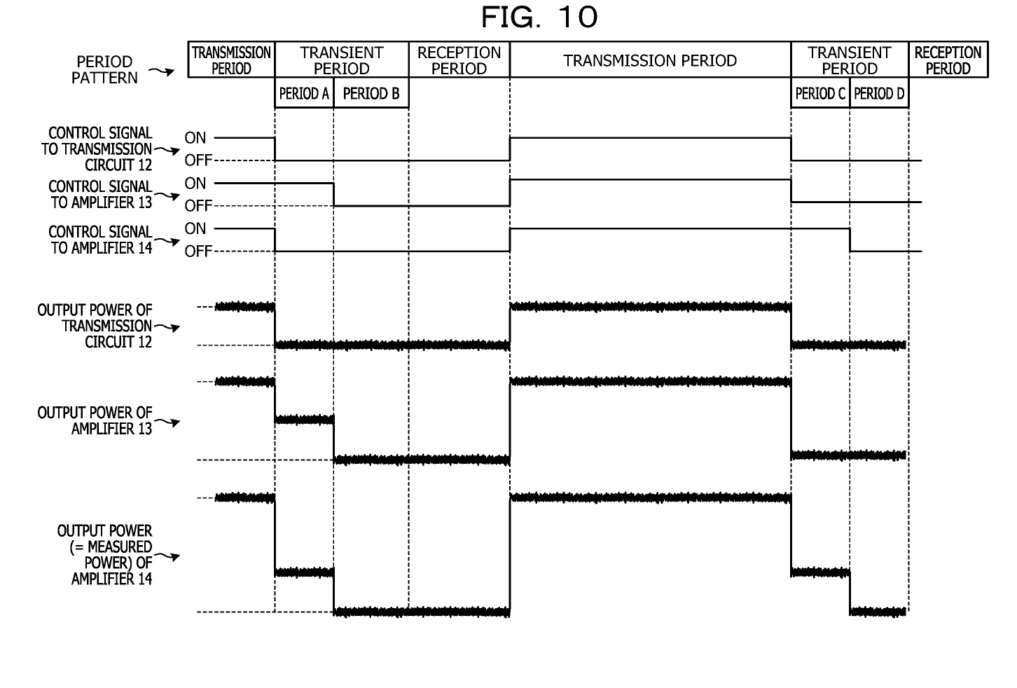

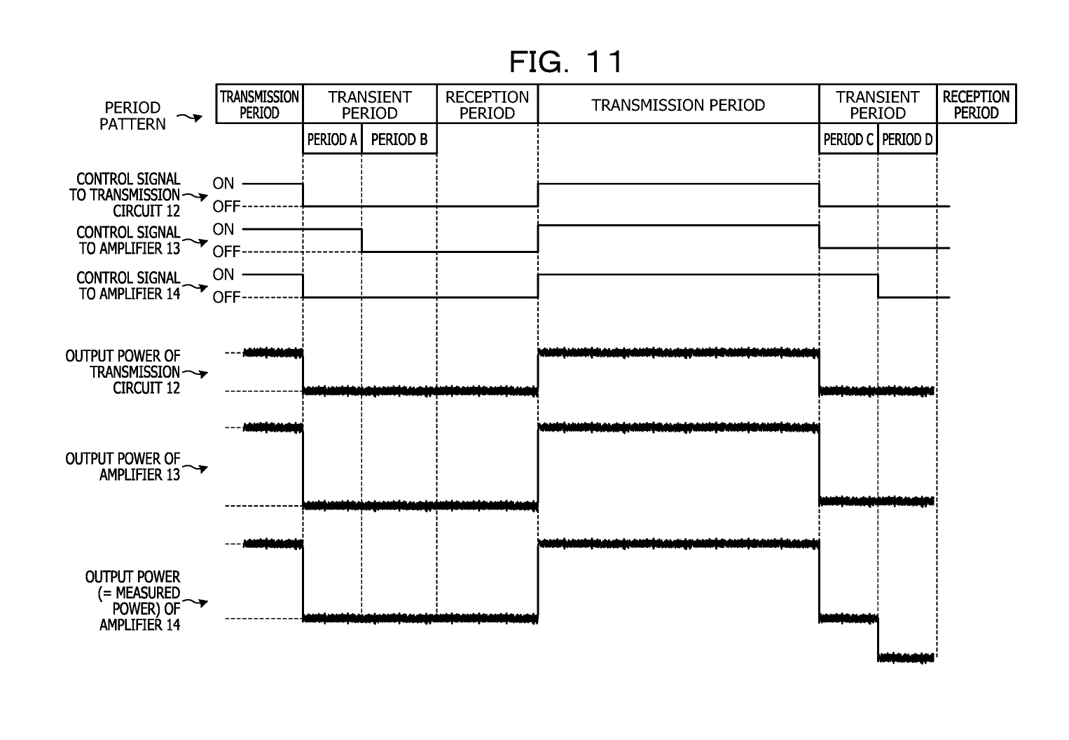

Now, a different example of failure decision based on the “change amount” of the power measured by the power measurement unit 16 is described. It is assumed that, in the following description, the amplifier 13 is the “amplifier of the decision target.” The failure decision unit 57 calculates the “difference” between a value of the power measured by the power measurement unit 16 within a given period after a “decision target timing” and a value of the power of a signal to be outputted from the amplifier 14 within the given period as the “change amount” described above. Then, when the calculated value of the “difference” is higher than a given threshold value, the failure decision unit 57 decides that a failure occurs in the amplifier 13. It is to be noted that the value of the power of a signal to be outputted from the amplifier 14 may be a value measured in advance upon fabrication or the like of the wireless apparatus 50.

<Example of Operation of Wireless Apparatus> An example of processing operation of the wireless apparatus 50 having the configuration described above is described. FIGS. 10 and 11 are views illustrating processing operation of the wireless apparatus of the embodiment 3. FIG. 10 relates to processing operation of a failure decision method by the wireless apparatus 50 when neither of the amplifiers 13 and 14 fails. FIG. 11 relates to processing operation of a failure decision method by the wireless apparatus 50 when the amplifier 13 fails.

First, processing operation when neither of the amplifiers 13 and 14 fails is described with reference to FIG. 10. As depicted at the uppermost stage in FIG. 10, the period is switched in the order of a transmission period, a transient period, a reception period, another transmission period, another transient period, and another reception period.

As depicted at the second stage from above in FIG. 10, when the transmission period comes to an end, the control signal outputting unit 51 outputs a control signal for switching the transmission circuit 12 from an on state to an off state. Consequently, the transmission circuit 12 is placed into an off state, and outputting of a wireless transmission signal from the transmission circuit 12 (for example, the amplifier 24) is stopped.

Further, when the “transient period” of the first time from a transmission period to a reception period comes, the failure decision unit 57 sets the amplifier 13 as the “amplifier of the decision target.” As depicted at the fourth stage from above in FIG. 10, the control signal outputting unit 51 outputs a control signal for switching the amplifier 14 from an on state to an off state under the control of the failure decision unit 57 at an end timing of the transmission period (for example, at a start timing of the “transient period” of the first time). Since the amplifier 14 does not fail, the amplifier 14 is placed into an off state by the control signal, and outputting of a noise signal from the amplifier 14 is stopped.

Then, in response to the stopping of the outputting of a wireless transmission signal from the transmission circuit 12 and a noise signal from the amplifier 14, the powers of signals to be outputted from the transmission circuit 12, the amplifier 13, and the amplifier 14 individually decrease as depicted at the fifth to seventh stages from above in FIG. 10.

Further, as depicted at the third stage from above in FIG. 10, the control signal outputting unit 51 outputs a control signal for switching the amplifier 13 from an on state to an off state under the control of the failure decision unit 57 at an output timing later than the output timing of the control signal corresponding to the amplifier 14. In the following description, an output timing corresponding to the amplifier 13 is referred to as “decision target timing.” Since the amplifier 13 does not fail, the amplifier 13 is placed into an off state by the control signal corresponding to the amplifier 13, and outputting of a noise signal from the amplifier 13 is stopped.

Then, in response to the stopping of the outputting of a noise signal from the amplifier 13, the powers of signals outputted from the amplifier 13 and the amplifier 14 individually decrease as depicted at the sixth and seventh stages from above in FIG. 10. The power of a signal outputted from the amplifier 14 is measured by the power measurement unit 16. The failure decision unit 57 calculates the “difference” between a value of the power measured by the power measurement unit 16 within a period A before the “decision target timing” described above and a value of the power measured by the power measurement unit 16 within a period B after the “decision target timing.” The “difference” is greater than the given threshold value because the amplifier 13 is in an off state normally. Then, the failure decision unit 57 decides that a failure does not occur in the amplifier 13 because the calculated value of the “difference” is higher than the given threshold value.

Further, when another “transient period” of the second time from a transmission period to a reception period comes, the failure decision unit 57 switches the “amplifier of the decision target” from the amplifier 13 to the amplifier 14. As depicted at the third stage from above in FIG. 10, the control signal outputting unit 51 outputs a control signal for switching the amplifier 13 from an on state to an off state under the control of the failure decision unit 57 at an end timing of the transmission period (for example, at a start timing of the “transient period” of the second time). Since the amplifier 13 does not fail, the amplifier 13 is placed into an off state by the control signal, and outputting of a noise signal from the amplifier 13 is stopped.

Then, in response to the stopping of the outputting of a wireless transmission signal from the transmission circuit 12 and a noise signal from the amplifier 13, the powers of signals outputted from the transmission circuit 12, the amplifier 13, and the amplifier 14 individually decrease as depicted at the fifth to seventh stages from above in FIG. 10.

Further, as depicted at the fourth stage from above in FIG. 10, the control signal outputting unit 51 outputs a control signal for switching the amplifier 14 from an on state to an off state at an output timing later than the output timing of the control signal corresponding to the amplifier 13. In the following description, the output timing corresponding to the amplifier 14 is referred to as “decision target timing.” Since the amplifier 14 does not fail, the amplifier 14 is placed into an off state by the control signal corresponding to the amplifier 14, and outputting of a noise signal from the amplifier 14 is stopped.

Then, in response to the stopping of the outputting of a noise signal from the amplifier 14, the power of a signal outputted from the amplifier 14 decreases as depicted at the seventh stage from above in FIG. 10. The power of a signal outputted from the amplifier 14 is measured by the power measurement unit 16. The failure decision unit 57 calculates the “difference” between a value of the power measured by the power measurement unit 16 within a period C before the “decision target timing” described above and a value of the power measured by the power measurement unit 16 within a period D after the “decision target timing.” The “difference” is greater than a given threshold value because the amplifier 14 is in an off state normally. Then, since the calculated value of the “difference” is higher than the given threshold value, the failure decision unit 57 decides that a failure does not occur in the amplifier 14.

Now, processing operation when the amplifier 13 fails is described with reference to FIG. 11. It is assumed that, as depicted at the uppermost stage in FIG. 11, the period is switched in the order of a transmission period, a transient period, a reception period, another transmission period, another transient period, and another reception period.

As depicted at the second stage from above in FIG. 11, when a transmission period comes to an end, the control signal outputting unit 51 outputs a control signal for switching the transmission circuit 12 from an on state to an off state. Consequently, the transmission circuit 12 is placed into an off state, and outputting of a wireless transmission signal from the transmission circuit 12 (for example, the amplifier 24) is stopped.

Further, when a “transient period” of the first time from the transmission period to a reception period comes, the failure decision unit 57 sets the amplifier 13 as the “amplifier of the decision target.” As depicted at the fourth stage from above in FIG. 11, the control signal outputting unit 51 outputs a control signal for switching the amplifier 14 from an on state to an off state under the control of the failure decision unit 57 at an end timing of the transmission period (for example, at a start timing of a “transient period” of the first time). Since the amplifier 14 does not fail, the amplifier 14 is placed into an off state by the control signal, and outputting of a noise signal from the amplifier 14 is stopped.

Then, in response to the stopping of the outputting of a wireless transmission signal from the transmission circuit 12 and a nose signal from the amplifier 14, the powers of signals outputted from the transmission circuit 12, the amplifier 13, and the amplifier 14 individually decrease as depicted at the fifth to seventh stages from above in FIG. 11.

Further, as depicted at the third stage from above in FIG. 11, the control signal outputting unit 51 outputs a control signal for switching the amplifier 13 from an on state to an off state at an output timing later than the output timing of the control signal corresponding to the amplifier 14 under the control of the failure decision unit 57. In the following description, an output timing corresponding to the amplifier 13 is referred to as “decision target timing.” Since the amplifier 13 fails, the amplifier 13 does not switch to an off state by the control signal corresponding to the amplifier 13, and the outputting of a noise signal from the amplifier 13 is not stopped.

Consequently, the powers of signals outputted from the amplifier 13 and the amplifier 14 do not individually decrease as depicted at the sixth and seventh stages from above in FIG. 11. The power of a signal outputted from the amplifier 14 is measured by the power measurement unit 16. The failure decision unit 57 calculates the “difference” between a value of the power measured by the power measurement unit 16 within a period A before the “decision target timing” described above and a value of the power measured by the power measurement unit 16 within a period B after the “decision target timing.” The “difference” is smaller than the given threshold value because the amplifier 13 is in an on state. Then, since the calculated value of the “difference” is lower than the given threshold value, the failure decision unit 57 decides that a failure occurs in the amplifier 13.

Further, when a “transient period” of the second time from a transmission period to a reception period comes, the failure decision unit 57 switches the “amplifier of the decision target” from the amplifier 13 to the amplifier 14. As depicted at the third stage from above in FIG. 11, the control signal outputting unit 51 outputs a control signal for switching the amplifier 13 from an on state to an off state under the control of the failure decision unit 57 at an end timing of the transmission period (for example, at a start timing of a “transient period” of the second time). Since the amplifier 13 fails, the amplifier 13 does not switch to an off state by the control signal, and outputting of a noise signal from the amplifier 13 is not stopped.

Then, in response to the stopping of the outputting of a wireless transmission signal from the transmission circuit 12, the powers of signals outputted from the transmission circuit 12, the amplifier 13, and the amplifier 14 individually decrease as depicted at the fifth to seventh stages from above in FIG. 11.

Further, as depicted at the fourth stage from above in FIG. 11, the control signal outputting unit 51 outputs a control signal for switching the amplifier 14 from an on state to an off state at an output timing later than the output timing of a control signal corresponding to the amplifier 13. In the following description, an output timing corresponding to the amplifier 14 is referred to as “decision target timing.” Since the amplifier 14 does not fail, the amplifier 14 is placed into an off state by the control signal corresponding to the amplifier 14, and outputting of a noise signal from the amplifier 14 is stopped.

Then, in response to the stopping of the outputting of a noise signal from the amplifier 14, the power of a signal outputted from the amplifier 14 decreases as depicted at the seventh stage from above in FIG. 11. The power of a signal outputted from the amplifier 14 is measured by the power measurement unit 16. The failure decision unit 57 calculates the “difference” between a value of the power measured by the power measurement unit 16 within a period C before the “decision target timing” described above and a value of the power measured by the power measurement unit 16 within a period D after the “decision target timing.” The “difference” is greater than the given threshold value because the amplifier 14 is in an off state normally. Then, since the calculated value of the “difference” is higher than the given threshold value, the failure decision unit 57 decides that a failure does not occur in the amplifier 14.

As described above, according to the present embodiment, in the wireless apparatus 50, every time a transient period comes, the control signal outputting unit 51 outputs a control signal for switching the amplifier of the decision target between on and off at an output timing later than an output timing of a control signal to a different amplifier. Every time a transient period comes, the failure decision unit 57 changes the amplifier of the decision target and decides a failure of the amplifier of the decision target based on a change amount of the power measured by the power measurement unit 16 at an output timing corresponding to the amplifier of the decision target after the change.

By this configuration of the wireless apparatus 50, a failure of one amplifier can be decided within one transient period, and a failure of each of the amplifiers 13 and 14 coupled in series can be decided with a reduced processing load.

### Other Embodiments

[1] While the embodiments 1 to 3 exemplify the amplifiers 13 and 14 that are two amplifiers coupled in series, the number of such amplifiers is not limited to two but may be three or more.

[2] While, in the description of the embodiments 1 to 3, decision of a failure of each of a plurality of amplifiers coupled in series is described, the “failure” may include not only a failure of an amplifier itself but also a failure of a signal line for transmitting a control signal to the amplifier.

[3] While, in the description of the embodiments 1 and 2, a case is described in which a failure of each of a plurality of amplifiers is decided, it is not limited to an occurrence of a failure, and a presage of a failure of each of a plurality of amplifiers may be decided. For example, the failure decision unit 17 in the embodiment 1 calculates the “difference” between a value of the power measured by the power measurement unit 16 within a given period after each of a “plurality of output timings” and a value of the power of a signal to be outputted from the amplifier 14 within the given period as a “change amount” described above. Then, when the calculated value of the “difference” is higher than a first threshold value, the failure decision unit 17 decides that a failure occurs in each of the amplifiers 13 and 14. On the other hand, when the calculated value of the “difference” is equal to or lower than the first threshold value, the failure decision unit 17 decides whether or not the “difference” is equal to or greater than a second threshold value. The second threshold value is lower than the first threshold value. When the “difference” is equal to or higher than the second threshold value, the failure decision unit 17 decides that a presage of a failure occurs in each of the amplifiers 13 and 14. A presage of a failure occurs originating from, for example, a drop of the gain.

[4] The components of the units indicated in the embodiments 1 to 3 described above may not necessarily be configured physically in such a manner as depicted in the figures. Further, particular forms of disintegration or integration of the units are not limited to those depicted in the figures, but may be configured by functionally or physically disintegrating or integrating the entire or part of them in an arbitrary unit in response to various loads, use situations and so forth.

Further, various processing functions performed by the respective apparatus may be entirely or arbitrarily partly executed by a central processing unit (CPU) (or a microcomputer such as a micro processing unit (MPU) or a micro controller unit (MCU)). Further, the various processing functions may be entirely or arbitrarily partly executed by a program that can be analyzed and executed by a CPU (or a microcomputer such as an MPU or an MCU) or by hardware by wired logics.

The wireless apparatus of the embodiments 1 to 3 described above can be implemented, for example, by such a hardware configuration as described below.

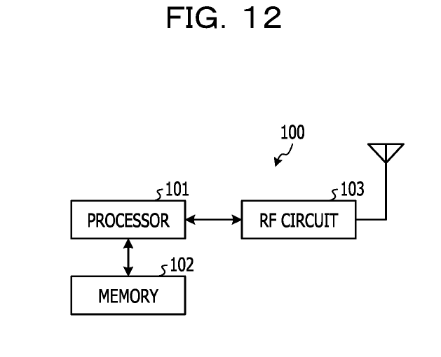

FIG. 12 is a view depicting an example of a hardware configuration of a wireless apparatus. As depicted in FIG. 12, a wireless apparatus 100 includes a processor 101, a memory 102, and a radio frequency (RF) circuit 103. As an example of the processor 101, a CPU, a digital signal processor (DSP), a field programmable gate array (FPGA) and so forth can be listed. Meanwhile, as an example of the memory 102, a random access memory (RAM) such as a synchronous dynamic random access memory (SDRAM), a read only memory (ROM), a flash memory and so forth can be listed.

Then, the various processing functions performed by the wireless apparatus in the embodiment 1 to the embodiment 3 may be implemented by a processor that is provided in an amplification apparatus and executes a program stored in various memories such as a nonvolatile storage medium.

For example, programs corresponding to the respective processes executed by the control signal outputting unit 11, 31, or 51, the power measurement unit 16, and the failure decision unit 17, 37, or 57 may be stored in the memory 102 and executed by the processor 101. Further, programs corresponding to the respective processes executed by the distortion compensation coefficient calculation unit 18, the LUT 19, and the multiplier 20 may be stored in the memory 102 and executed by the processor 101. Further, the transmission circuit 12, the amplifiers 13 and 14, and the coupler 15 are implemented by the RF circuit 103.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless apparatus comprising:
a plurality of amplifiers coupled in series with each other; and
a processor coupled to the plurality of amplifiers and configured to
execute an outputting process to output a plurality of control signals for switching each of the plurality of amplifiers between on and off at a plurality of output timings, the outputting process causing at least one of the plurality of amplifiers to operate in a way that length of duration in which the at least one of the plurality of amplifiers is set in on state is different from at least one amplifier among rest of the plurality of amplifiers,
execute a measurement process to measure power of a signal outputted from an amplifier at the last stage from among the plurality of amplifiers, and
execute a decision process to decide a failure of each of the plurality of amplifiers based on a change amount of the power measured by the measurement process at each of the plurality of output timings.

2. The wireless apparatus according to claim 1,
wherein the wireless apparatus is configured to operate by a time-division multiplexing method that involves division in time into a transmission period and a reception period;
in the outputting process, the processor is configured to output the plurality of control signals for switching each of the plurality of amplifiers from an on state to an off state at the plurality of output timings included in a transient period from the transmission period to the reception period, in a way that length of duration in which the at least one of the plurality of amplifiers is set in on state during the transient period is different from at least one amplifier among rest of the plurality of amplifiers; and
in the decision process, the processor is configured to decide a failure indicating that each of the plurality of amplifiers does not switch to an off state based on the change amount of the power measured by the measurement process at each of the plurality of output timings.

3. The wireless apparatus according to claim 1,
wherein in the outputting process, the processor is configured to output the plurality of control signals for switching each of the plurality of amplifiers from an off state to an on state at the plurality of output timings included in a transient period from the reception period to the transmission period, in a way that length of duration in which the at least one of the plurality of amplifiers is set in on state during the transient period is different from at least one amplifier among rest of the plurality of amplifiers; and
in the decision process, the processor is configured to decide a failure indicating that each of the plurality of amplifiers does not switch to an on state based on the change amount of the power measured by the measurement process at each of the plurality of output timings.

4. The wireless apparatus according to claim 1,
wherein in the decision process, the processor is configured to detect a presage of the failure based on the change amount of the power measured by the measurement process at each of the plurality of output timings.

5. The wireless apparatus according to claim 1,
wherein the wireless apparatus is configured to operate by a time-division multiplexing method that involves division in time into a transmission period and a reception period;
in the outputting process, the processor is configured to output a plurality of control signals for switching each of the plurality of amplifiers between on and off at a plurality of output timings included in a transient period from the transmission period to the reception period, in a way that length of duration in which a decision target from among the plurality of amplifiers is set in on state during the transient period is different from at least one amplifier among rest of the plurality of amplifiers except the decision target; and
in the decision process, the processor is configured to change, every time the transient period comes, the decision target to at least one amplifier among the rest of the plurality of amplifiers and decide a failure of the decision target after the change based on the change amount of the power measured by the measurement process at each of the plurality of output timings.

6. A failure decision method for a wireless apparatus including a plurality of amplifiers coupled in series with each other, the method comprising:
executing, by a processor, an outputting process to output a plurality of control signals for switching each of the plurality of amplifiers between on and off at a plurality of output timings, the outputting process causing at least one of the plurality of amplifiers to operate in a way that length of duration in which the at least one of the plurality of amplifiers is set in on state is different from at least one amplifier among rest of the plurality of amplifiers;
executing, by a processor, a measurement process to measure power of a signal outputted from an amplifier at the last stage from among the plurality of amplifiers; and
executing, by a processor, a decision process to decide a failure of each of the plurality of amplifiers based on a change amount of the power measured by the measurement process at each of the plurality of output timings.

7. The failure decision method according to claim 6,
wherein the wireless apparatus is configured to operate by a time-division multiplexing method that involves division in time into a transmission period and a reception period;
the outputting process includes outputting the plurality of control signals for switching each of the plurality of amplifiers from an on state to an off state at the plurality of output timings included in a transient period from the transmission period to the reception period, in a way that length of duration in which the at least one of the plurality of amplifiers is set in on state during the transient period is different from at least one amplifier among rest of the plurality of amplifiers; and
the decision process includes deciding a failure indicating that each of the plurality of amplifiers does not switch to an off state based on the change amount of the power measured by the measurement process at each of the plurality of output timings.

8. The failure decision method according to claim 6,
wherein the outputting process includes outputting the plurality of control signals for switching each of the plurality of amplifiers from an off state to an on state at the plurality of output timings included in a transient period from the reception period to the transmission period, in a way that length of duration in which the at least one of the plurality of amplifiers is set in on state during the transient period is different from at least one amplifier among rest of the plurality of amplifiers; and
the decision process includes deciding a failure indicating that each of the plurality of amplifiers does not switch to an on state based on the change amount of the power measured by the measurement process at each of the plurality of output timings.

9. The failure decision method according to claim 6,
wherein the decision process includes detecting a presage of the failure based on the change amount of the power measured by the measurement process at each of the plurality of output timings.

10. The failure decision method according to claim 6,
wherein the wireless apparatus is configured to operate by a time-division multiplexing method that involves division in time into a transmission period and a reception period;
the outputting process includes outputting a plurality of control signals for switching each of the plurality of amplifiers between on and off at a plurality of output timings included in a transient period from the transmission period to the reception period, in a way that length of duration in which a decision target from among the plurality of amplifiers is set in on state during the transient period is different from at least one amplifier among rest of the plurality of amplifiers except the decision target; and
the decision process includes changing, every time the transient period comes, the decision target to at least one amplifier among the rest of the plurality of amplifiers and deciding a failure of the decision target after the change based on the change amount of the power measured by the measurement process at each of the plurality of output timings.
